(19) United States
(12) Patent Application Publication
(10) Pub. No.: US 2005/0256710 A1
(43) Pub. Date: Nov. 17, 2005

(54) Text message generation

(75) Inventors: Matthias Pankert, Aachen (DE); Reimund Schmald, Aachen (DE); Jens Marschner, Wurselen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/507,194

(22) PCT Filed: Mar. 10, 2003
(86) PCT No.: PCT/IB03/00890

§ 371 Date: Sep. 9, 2004

(30) Foreign Application Priority Data
Mar. 14, 2002 (DE) 102 11 777.2

(51) Int. Cl. G10L 15/26

(52) U.S. Cl. 704/235

(57) ABSTRACT

The invention relates to a method of generating text messages. In order to make the generation of text messages as convenient and efficient as possible for a user, the following steps are proposed: —processing of speech input containing message elements by means of grammar-based speech recognition procedures; —processing of speech input by means of speech model-based speech recognition procedures, either in parallel with processing by means of grammar-based speech recognition or once a recognition result has been obtained by means of the grammar-based speech recognition procedures which is not of a predefined quality; —generation of a text message using the recognition results produced by means of the grammar-based and/or speech model-based speech recognition procedures.

The invention relates to a method of generating text messages.

The sending of text messages, in particular so-called SMS (Short Message Service) messages via telecommunications systems involves the transmission of messages via communications networks, in particular mobile radio systems and/or the Internet. Generating text messages by means of keyboard input is frequently awkward for the user, especially for users of mobile radio terminals with small keypads and generally multiple key assignments. This situation is improved by the possibility of speech input and by using systems with automatic speech recognition. In one possible scenario, a mobile radio terminal user wanting to generate an SMS message calls an automatic telephone service, which includes an automatic dialog system with speech recognition. Automatic dialog systems are known for a plurality of applications. A dialog then proceeds, in which the user inputs the text message and specifies the recipient of the text message, such that the text message may subsequently be sent to the recipient.

A description of the fundamentals of an automatic dialog system may be found for example in A. Kellner, B. Rüber, F. Seide and B. H. Tran, “PADIS—AN AUTOMATIC TELEPHONE SWITCHBOARD AND DIRECTORY INFORMATION SYSTEM”, Speech Communication, vol. 23, pages 95-111, 1997. Speech utterances made by a user are received here via an interface to a telephone network A system reply (speech output) is generated by the dialog system in response to speech input, which system reply is transmitted via the interface and onwards via the telephone network to the user. Speech inputs are converted by a speech recognition unit based on hidden Markov models (HMM) into a word lattice, which indicates in compressed form various word sequences constituting possible recognition results for the received speech utterance.

It is an object of the invention to provide a method of generating text messages which is as convenient as possible for a user and is also efficient.

The object is achieved by the following steps:
processing of speech input containing message elements by means of grammar-based speech recognition procedures;
processing of speech input by means of speech model-based speech recognition procedures, either in parallel with processing by means of grammar-based speech recognition or once a recognition result has been obtained by means of the grammar-based speech recognition procedures which is not of a predefined quality;
generation of a text message using the recognition results produced by means of the grammar-based and/or speech model-based speech recognition procedures.

With such a method, the user may conveniently generate text messages by means of speech input. Conversion of speech input into a text message is in this case very reliable, being ensured on the one hand by the selection of suitable grammar and on the other hand by the selection of a speech model adapted to the respective application or user target group, wherein the speech model is conventionally based on n-grams. Telephone numbers, time and date details are reliably recognized by means of the grammar-based speech recognition procedures. In the case of freely formulated speech input, the speech model-based speech recognition procedures ensure that a recognition result of the highest possible reliability is available. Computing power is reduced by applying speech model-based recognition procedures to the speech input only when the recognition result provided by the grammar-based speech recognition procedures is not of a predefined quality, i.e. in particular does not reach a predetermined level-of-confidence threshold. Parallel processing of speech input by means of grammar- and speech model-based speech recognition is an alternative approach and likewise results in an extremely high level of reliability in the recognition of speech input.

For speech model-based speech recognition procedures, a plurality of different speech models may in particular also be used, which have been generated for various applications and target groups. This may be used to improve reliability in the generation of text messages by means of speech input.

In one embodiment, selection of the speech model that is most suitable in each case is made dependent on the result of the grammar-based speech recognition procedures performed beforehand. This exploits the fact that even an incorrect recognition result determined by means of the grammar-based speech recognition procedures contains information that may be used to select a suitable speech model, e.g. individual words which point to a subject or application.

Another embodiment in which various speech models are likewise used omits evaluation of the result of a grammar-based speech recognition for selection of the speech model that is most suitable in each case and applies the speech model-based speech recognition procedures repeatedly to the speech input using different speech models. By comparing the associated level-of-confidence values, the most reliable result alternative is selected as the recognition result from the recognition result alternatives produced.

The object is also achieved by a method of generating text messages, the method having the following steps:
processing of speech input containing message elements by means of speech model-based speech recognition procedures in order to generate a word lattice representing word sequence alternatives;
processing of the word lattice by means of a parser;
generation of a text message using the recognition result produced by the parser or selection of a word sequence alternative from the word lattice.

Furthermore, the object is achieved by a method of generating text messages having the following steps:
processing of speech input by means of speech model-based speech recognition procedures, wherein various speech models are used to generate a corresponding number of recognition results;
determination of level-of-confidence values for the recognition results;
generation of a text message using the recognition result with the best level-of-confidence value.

The methods according to the invention for generating text messages are used in particular in an automatic dialog system which transmits the generated text message, for example an SMS (Short Message Service) message via a telecommunications network to a previously selected addressee. Speech input may be effected for example by means of a mobile radio. The speech input is transmitted over the telephone network to the automatic dialog system (telephone service), which converts the speech input into a text message, which is in turn transmitted for example to another mobile radio subscriber. Both the generator of the speech input representing a message and the addressee of the respective message may of course also use a computer, connected for example to the Internet, to process the speech input or receive the text message.

The invention also relates to a computer system and a computer program for performing the method according to the invention as well as to a computer-readable data storage medium with such a computer program.

The invention will be further described with reference to examples of embodiments shown in the drawings to which, however, the invention is not restricted. In the Figures:

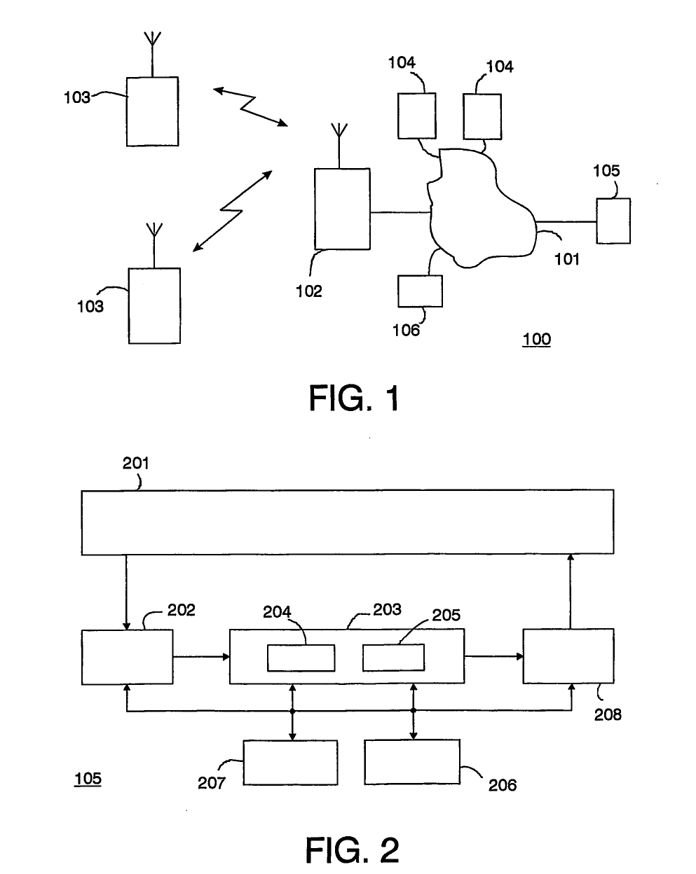

FIG. 1 shows a telecommunications system with system components for generating and transmitting text messages,

FIG. 2 shows a dialog system for use in generating text messages and

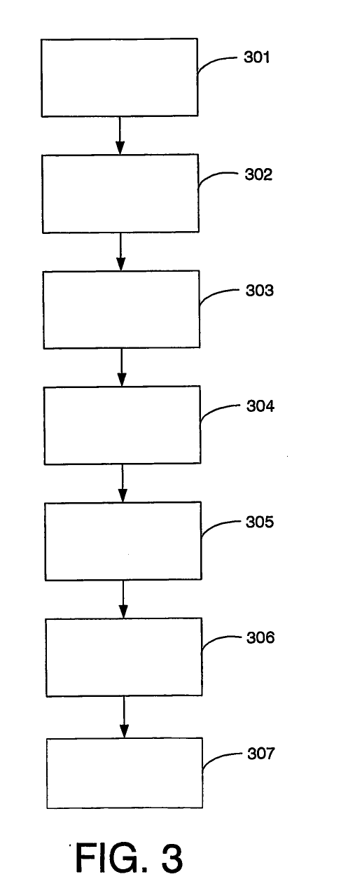

FIGS. 3 to 7 are flow charts explaining the generation according to the invention of text messages and

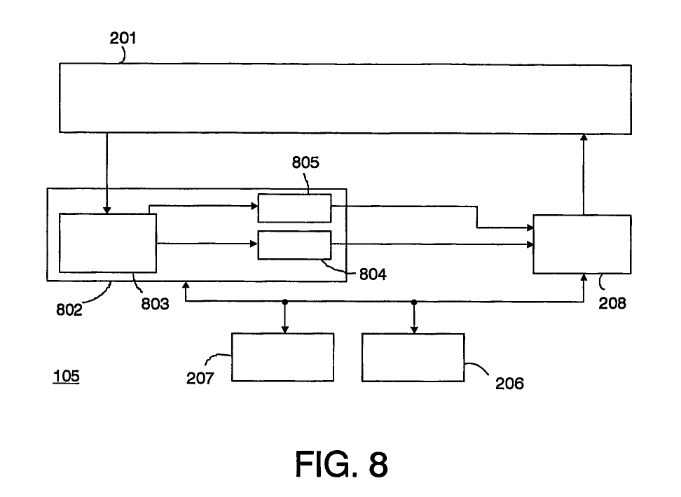

FIG. 8 is a block diagram of a dialog system variant.

In the case of the telecommunications system 100 illustrated in FIG. 1, a telecommunications network 101 is provided which in particular comprises one or more mobile radio networks and/or a public landline network (PSTN, Public Switched Telephone Network) and/or the Internet. FIG. 1 shows examples of mobile radio system components, i.e. a mobile radio base station 102 connected to the telecommunications network 101 and mobile radio terminals 103, which are located within the reception range of the base station 102. The Figure additionally shows, by way of example, two personal computers 104 coupled to the telecommunications network 101 and a telephone terminal 106 coupled to the telecommunications network 101. Furthermore, FIG. 1 shows a dialog system 105 connected to the telecommunications network 101 and implemented on a computer system.

FIG. 2 shows a block diagram explaining the system functions of the dialog system 105. Signal exchange with the telecommunications network 101 takes place at an interface 201. A received speech signal, which was received for example by means of a microphone of a mobile radio 103 or the personal computer 104 or the telephone terminal 106 and transmitted via the telecommunications network 101 to the computer system 105, is subjected after reception via an interface 201 to feature extraction by means of a preprocessing unit 202, during which feature vectors are formed which are converted by speech recognition procedures 203 into a speech recognition result. Both grammar-based speech recognition procedures 204 and speech model-based speech recognition procedures 205 are provided, wherein grammar-based speech recognition procedures are known in principle for example from the above mentioned article by A. Kellner, B. Rüber, F. Seide and B. H. Tran, “PADIS—AN AUTOMATIC TELEPHONE SWITCHBOARD AND DIRECTORY INFORMATION SYSTEM”, Speech Communication, vol. 23, pages 95-111, 1997 and speech model-based speech recognition procedures for example from “THE PHILIPS RESEARCH SYSTEM FOR CONTINUOUS-SPEECH RECOGNITION” by V. Steinbiss et. al., Philips J. Res. 49 (1995) 317-352. In a preferred embodiment the preprocessing unit 202 may also be an integral part of the speech recognition procedures 203. A block 206 coordinates control functions in speech signal processing. Application-specific data necessary for operation of the dialog system are stored in a data memory represented by a block 207. These are in particular data for conducting a dialog with a user and one or more grammars or sub-grammars and one or more speech models for performing respectively the grammar-based speech recognition procedures 204 and the speech model-based speech recognition procedures 205. The control unit 206 generates system outputs as a function of the respective speech recognition result and optionally a previous dialog sequence, which system outputs are transmitted via the interface 201 and the telecommunications network 101 to the user who generated the respective speech input or are also transmitted as signals representing text messages to one or more users, i.e. to their telecommunications terminals, such as for example mobile radio terminals or personal computers. The generation of system outputs, i.e. of speech signals or text messages, is coordinated by a block 208.

FIG. 3 shows a first flow chart for explaining the generation of text messages according to the invention. Block 301 coordinates the output of a greeting by the dialog system 105, which has been called by a user in order to send a text message by speech input. The greeting informs the user for example that he/she has called a telephone service for generating text messages (in particular short messages, SMS). In step 302, the user is invited to input an address (e.g. a telephone number or an email address), to which a text message is to be transmitted once it has been input. In step 303, the user is invited to input a text message, this being followed, in step 304, by the speech input of a text message by the user. In step 305, this speech input is converted into a text message using the preprocessing means 202 and the speech recognition procedures 203. In step 306 a message is then generated, optionally after a verification dialog following the end of step 305, on the basis of the thus generated text message and the input address, which message is output by the output unit 208 via the interface 201 to the telecommunications network 101. In a step 307, the text message is transmitted in accordance with the input address to the selected receiver, e.g. a mobile radio 103 or a personal computer 104.

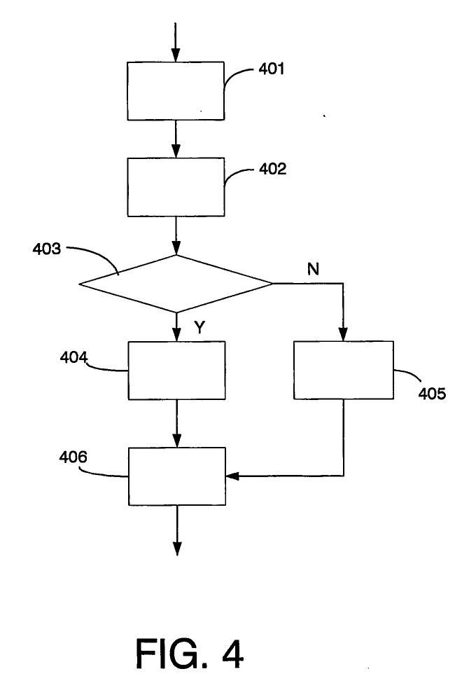

In the example of embodiment according to FIG. 4, the processing step 305 is explained in more detail. Firstly, in a step 402 processing is performed by means of the grammar-based speech recognition procedures 204 for the entire speech input. In this process, particularly frequently occurring words or word sequences, e.g. telephone numbers, time details or date details, are identified and recognized with a high level of reliability. In step 402, a level-of-confidence value is additionally determined for the recognition result provided by the grammar-based speech recognition procedures, which level-of-confidence value is compared with a level-of-confidence threshold value in step 403. If the level-of-confidence value determined in step 402 reaches the predetermined level-of-confidence threshold value, i.e. the recognition result provided by the grammar-based speech recognition procedures is sufficiently reliable, the recognition result generated in step 402 or the information contained therein is used to generate a text message, wherein predefined text messages are used, which contain variable text components, which are in turn determined by means of the recognition result generated in step 402. The result of step 402 consists of phrases (sentence components) or sentences, valid with regard to grammar, with associated confidence values. In step 404, the best possible correspondence of these phrases with preformulated sentences is looked for. These preformulated sentences may contain variables (e.g. date, telephone number), which are optionally filled in with recognized phrases.

If the comparison performed in step 403 indicates that the predetermined level-of-confidence threshold value is not reached (insufficient reliability of the recognition result of the grammar-based speech recognition procedures), the speech model-based procedures 205 are applied to the speech input or the feature vectors generated by the preprocessing unit 202 (step 405).

Step 404 or step 405 is followed by an optional step 406, in which the user is invited to verify the text message generated in step 404 or 405. In this step, before the text message is sent off to the recipient the text message generated is presented (read out) to the user for verification, for example by means of speech synthesis, or the generated text message is presented to the user in text form for verification (displayed on a device display).

If the user refuses verification in step 406, alternative text messages are output to the user, which are generated by using recognition result alternatives of the grammar-based speech recognition procedures or speech model-based speech recognition procedures. If a text message output to the user is verified by him/her in step 406, steps 306 and 307 according to FIG. 3 are performed. If no verification dialog according to step 406 is provided, steps 306 and 307 follow directly on step 404 or step 405.

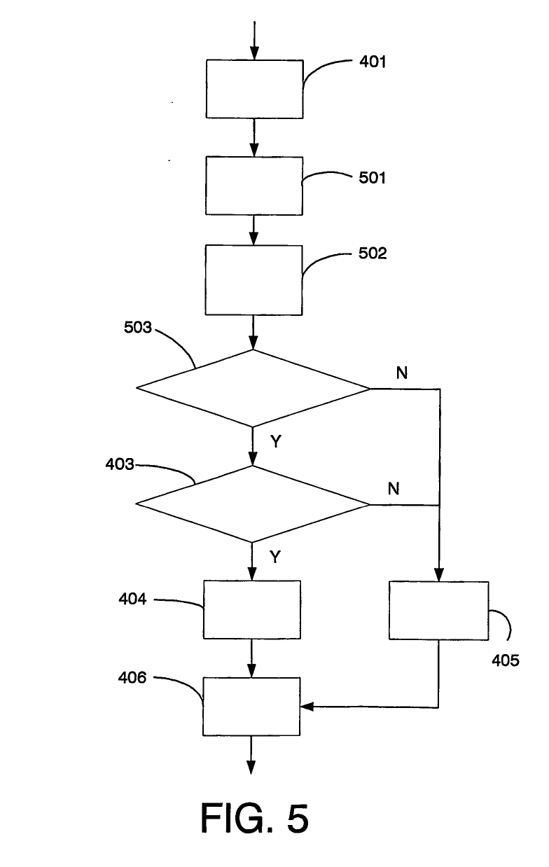

In the example of embodiment according to FIG. 5, in a step 501 the grammar-based speech recognition procedures are separately applied to only one or more parts of the speech input, instead of to the whole speech input (step 402 in FIG. 4). The established speech recognition results, which are determined in step 501, are compared in step 502 with predefined text message patterns. Step 503 represents an inquiry as to whether a corresponding text message pattern could be found in step 502. If such a corresponding pattern was found, steps 403, 404 and 406 follow, as in the example of embodiment according to FIG. 4. If no corresponding text message pattern is found, the speech model-based speech recognition procedures are applied to the speech input (step 405), which may optionally again be followed in step 406 by an optional verification dialog as in the example of embodiment according to FIG. 4.

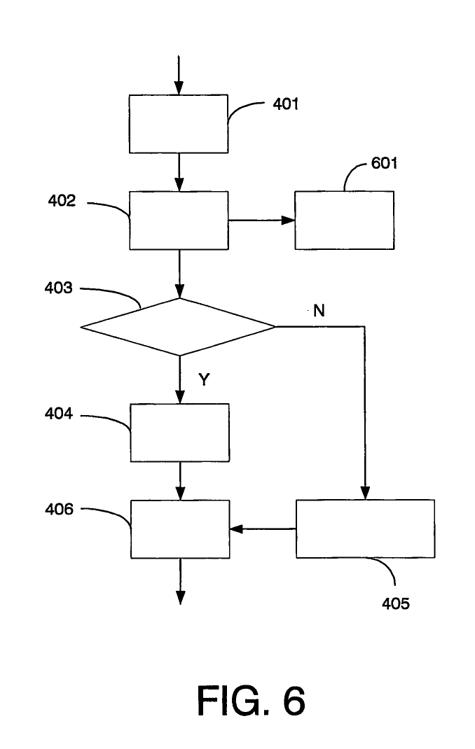

The example of embodiment according to FIG. 6 shows a variant of the example of embodiment according to FIG. 4, in which the result of the grammar-based speech recognition procedures in step 402 is used to select a speech model for the speech model-based speech recognition procedures. For example, certain key words which indicate a particular subject area, are analyzed here for selection of the speech model in step 601.

Instead of the speech model-based speech recognition procedures with fixed speech model (step 405), speech model-based speech recognition procedures are here applied to the speech input in a step 405 using the speech model selected in step 601, which is thus variable, if it has emerged in step 403 that the level-of-confidence threshold value has not been reached.

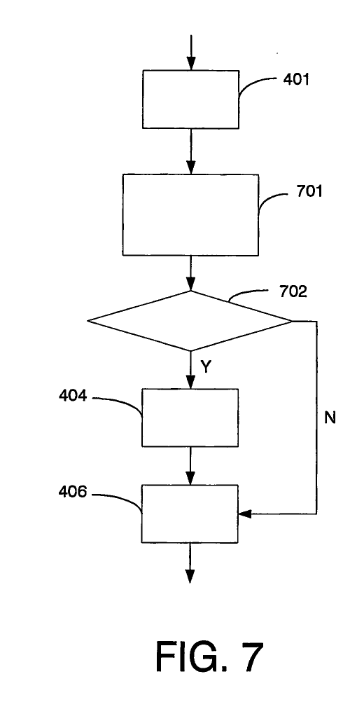

In the example of embodiment according to FIG. 7, the speech input features provided by the preprocessing in step 401 are processed in parallel in a step 701 by means of the grammar-based speech recognition procedures 204 and the speech model-based speech recognition procedures 205. A first confidence value is determined for the recognition result of the grammar-based speech recognition and a second confidence value is determined for the result of the speech model-based speech recognition, which confidence values are compared with one another in a step 702. If the first level-of-confidence value is greater than the second level-of-confidence value, the steps 404 and 406 follow, as in the previous examples of embodiment. If the first level-of-confidence value is not greater than the second level-of-confidence value, i.e. if the results of the grammar-based speech recognition procedures are no more reliable than the result of the speech model-based speech recognition procedures, the recognition result of the speech model-based speech recognition procedures is used to generate the text message. The optional verification dialog of step 406 may again optionally follow.

FIG. 8 shows a further implementation variant of the dialog system according to FIG. 2. The interface 201, the control unit 206, the database 207 and the output unit 208 are also present in this embodiment. The control unit 206 and the database 207 influence processing by means of speech recognition procedures 802, which comprise an n-gram speech recognition device 803, a parser 804 and a post-processing unit 805. A word lattice is generated by means of the n-gram speech recognition device 803 designed to perform feature extraction and speech model-based speech recognition procedures from a speech signal received via the interface 201. This is then parsed with a parser 804 by means of a grammar, i.e. grammar-based speech recognition procedures are performed. The recognition result generated in this way is forwarded to the output unit 208, if the generated recognition result is satisfactory. If the grammar-based processing in block 804 does not produce a satisfactory result, the best word sequence alternative derivable from the word lattice generated by the n-gram speech recognition device 803 is defined as recognition result, i.e. as text message, in a post-processing unit represented by a block 805 on the basis of said word lattice and is forwarded to the output unit 208, which outputs the generated text message to the respective addressees.

1. A method of generating text messages, having the following steps:
processing of speech input containing message elements by means of grammar-based speech recognition procedures;
processing of speech input by means of speech model-based speech recognition procedures, either in parallel with processing by means of grammar-based speech recognition or once a recognition result has been obtained by means of the grammar-based speech recognition procedures which is not of a predefined quality;
generation of a text message using the recognition results produced by means of the grammar-based and/or speech model-based speech recognition procedures.

2. A method as claimed in claim 1, characterized in that processing of the speech input by means of speech model-based speech recognition procedures takes place when the recognition result produced by means of the grammar-based speech recognition procedures does not reach a predeterminable level-of-confidence threshold value.

3. A method as claimed in claim 1, characterized in that selection of a speech model from a number of speech models is provided depending on the results of the grammar-based speech recognition and
the selected speech model is used for processing by means of the speech model-based speech recognition procedures.

4. A method as claimed in claim 1, characterized in that the text message generated is presented to the sender by means of speech synthesis or visually for verification purposes, before it is sent to the recipient.

5. A method of generating text messages, having the following steps:
processing of speech input containing message elements by means of speech model-based speech recognition procedures in order to generate a word lattice representing word sequence alternatives;
processing of the word lattice by means of a parser;
generation of a text message using the recognition result produced by the parser or selection of a word sequence alternative from the word lattice.

6. A method of generating text messages, having the following steps:
processing of speech input by means of speech model-based speech recognition procedures, wherein various speech models are used to generate a corresponding number of recognition results;
determination of level-of-confidence values for the recognition results;
generation of a text message using the recognition result with the best level-of-confidence value.

7. Use of the method as claimed in any one of claims 1 to 6 in operating an automatic dialog system, which transmits the generated text message via a telecommunications network.

8. A computer system having
means for processing speech input containing message elements by means of grammar-based speech recognition procedures;
means for processing speech input by means of speech model-based speech recognition procedures, either in parallel with processing by means of grammar-based speech recognition or once a recognition result has been obtained by means of the grammar-based speech recognition procedures which is not of a predefined quality;
means for generating a text message using the recognition results produced by means of the grammar-based and/or speech model-based speech recognition procedures.

9. A computer program for performing the method as claimed in any one of claims 1 to 6.

10. A computer-readable data storage medium, on which a computer program as claimed in claim 9 is stored.
